(19) United States
(12) Patent Application Publication
(10) Pub. No.: US 2016/0034429 A1
(43) Pub. Date: Feb. 4, 2016

(54) PACED PAGE AUTOMATIC TURNS

(71) Applicant: Kobo Inc., Toronto (CA)

(72) Inventors: James Wu, Newmarket (CA); Benjamin Landau, Toronto (CA)

(21) Appl. No.: 14/448,676

(22) Filed: Jul. 31, 2014

(51) Int. Cl. G06F 17/21; G06F 3/0484; G06F 3/0483

(52) U.S. Cl. CPC G06F 17/217; G06F 3/0483; G06F 3/04842

(57) ABSTRACT

A computing device includes a housing and a display assembly having a screen. The housing at least partially circumvents the screen so that the screen is viewable. A processor is provided within the housing to display content pertaining to a first page state for an e-book, and to initiate a countdown timer based on a first timer value. Upon expiration of the countdown timer, the processor automatically transitions the displayed content to correspond with a second page state of the e-book.

### TECHNICAL FIELD

Examples described herein relate to a computing device that automatically transitions a display state pertaining to paginated content.

### BACKGROUND

An electronic personal display is a mobile electronic device that displays information to a user. While an electronic personal display is generally capable of many of the functions of a personal computer, a user can typically interact directly with an electronic personal display without the use of a keyboard that is separate from or coupled to but distinct from the electronic personal display itself. Some examples of electronic personal displays include mobile digital devices/tablet computers such (e.g., Apple iPad®, Microsoft® Surface™, Samsung Galaxy Tab® and the like), handheld multimedia smartphones (e.g., Apple iPhone®, Samsung Galaxy S®, and the like), and handheld electronic readers (e.g., Amazon Kindle®, Barnes and Noble Nook®, Kobo Aura H D, and the like).

Some electronic personal display devices are purpose built devices that are designed to perform especially well at displaying readable content. For example, a purpose built purpose build device may include a display that reduces glare, performs well in high lighting conditions, and/or mimics the look of text on actual paper. While such purpose built devices may excel at displaying content for a user to read, they may also perform other functions, such as displaying images, emitting audio, recording audio, and web surfing, among others.

In some instances, e-reader devices are purpose-built devices designed to perform especially well at displaying readable content. For example, a purpose built e-reader device includes a display that reduces glare, performs well in highly lit conditions, and/or mimics the look of text on actual paper. While such purpose built e-reader devices excel at displaying content for a user to read, they can also perform other functions, such as displaying images, emitting audio, recording audio, and web surfing, among others.

There also exist numerous kinds of consumer devices that can receive services and resources from a network service. Such devices can operate applications or provide other functionality that links the device to a particular account of a specific service. For example, e-reader devices typically link to an online bookstore, and media playback devices often include applications which enable the user to access an online media library. In this context, the user accounts can enable the user to receive the full benefit and functionality of the device.

### BRIEF DESCRIPTION OF THE DRAWINGS

FIG. 1 illustrates a system for utilizing applications and providing e-book services on a computing device, according to an embodiment.

FIG. 2 illustrates an example of an e-reading device or other electronic personal display device, for use with one or more embodiments described herein.

FIGS. 3A-3B illustrate embodiments of an e-reading device that automatically transitions a display state based on a countdown timer.

FIG. 4 illustrates an e-reading system for displaying e-book content, according to one or more embodiments.

FIG. 5 illustrates a method of transitioning paginated e-book content based on a countdown timer, according to one or more embodiments.

### DETAILED DESCRIPTION

Embodiments described herein provide for a computing device that automatically transitions a display state pertaining to paginated content. In some embodiments, the display state may pertain to paginated content such as, for example, e-book content. Accordingly, each display state may correspond with a different page state of an e-book. Still further, in some embodiments, each display state transition may be triggered based on a countdown timer.

According to some embodiments, a computing device includes a housing and a display assembly having a screen. The housing at least partially circumvents the screen so that the screen is viewable. A processor is provided within the housing to display content pertaining to a first page state for an e-book, and to initiate a countdown timer based on a first timer value. Upon expiration of the countdown timer, the processor automatically transitions the displayed content to correspond with a second page state of the e-book.

For some embodiments, the processor may display a representation of the countdown timer on the screen of the display assembly. In a particular embodiment, the representation may indicate a current state of the countdown timer. For example, the representation may notify a user of an amount of time remaining (e.g., on the countdown timer) until the displayed content is to transition to the second page state of the e-book. The countdown timer may be reset upon transiting the displayed content from the first page state to the second page state.

Further, for some embodiments, the computing device may be responsive to one or more user inputs. For example, the processor may receive a first user input corresponding to a transition delay. In response to the first user input, the processor may adjust the countdown timer to delay the transitioning of the displayed content. In another example, the processor may receive a second user input corresponding to a page turn. In response to the second user input, and prior to expiration of the countdown timer, the processor may transition the displayed content to correspond with the second page state.

The countdown timer may substantially correspond with a user's reading speed. For example, in some embodiments, the first timer value may be a user-programmable value. In other embodiments, the first timer value may be determined based, at least in part, on an average duration between successive page transitions of the e-book. For example, the processor may increase the first timer value upon receiving a first user input that corresponds to a transition delay. Further, the processor may decrease the first timer value upon receiving a second user input that corresponds to a page turn.

Among other benefits, examples described herein provide an enhanced reading experience to users of e-reading devices (or similar computing devices). For example, automatically transitioning the display state of an e-reading device reduces the amount of user interaction required to operate the device. Moreover, by adjusting (e.g., increasing and/or decreasing) the first timer value based on received user inputs, the countdown timer may track and adapt to the user's actual reading speed. In addition, by controlling the pace at which new content is displayed to the user, embodiments herein may be used to help improve the user's reading speed.

“E-books” are a form of an electronic publication that can be viewed on computing devices with suitable functionality. An e-book can correspond to a literary work having a pagination format, such as provided by literary works (e.g., novels) and periodicals (e.g., magazines, comic books, journals, etc.). Optionally, some e-books may have chapter designations, as well as content that corresponds to graphics or images (e.g., such as in the case of magazines or comic books). Multi-function devices, such as cellular-telephony or messaging devices, can utilize specialized applications (e.g., e-reading apps) to view e-books. Still further, some devices (sometimes labeled as “e-readers”) can be centric towards content viewing, and e-book viewing in particular.

An “e-reading device” can refer to any computing device that can display or otherwise render an e-book. By way of example, an e-reading device can include a mobile computing device on which an e-reading application can be executed to render content that includes e-books (e.g., comic books, magazines etc.). Such mobile computing devices can include, for example, a multi-functional computing device for cellular telephony/messaging (e.g., feature phone or smart phone), a tablet device, an ultramobile computing device, or a wearable computing device with a form factor of a wearable accessory device (e.g., smart watch or bracelet, glasswear integrated with computing device, etc.). As another example, an e-reading device can include an e-reader device, such as a purpose-built device that is optimized for e-reading experience (e.g., with E-ink displays etc.).

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or a software or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer programs, or a computer usable carrier medium capable of carrying such a program.

System Description

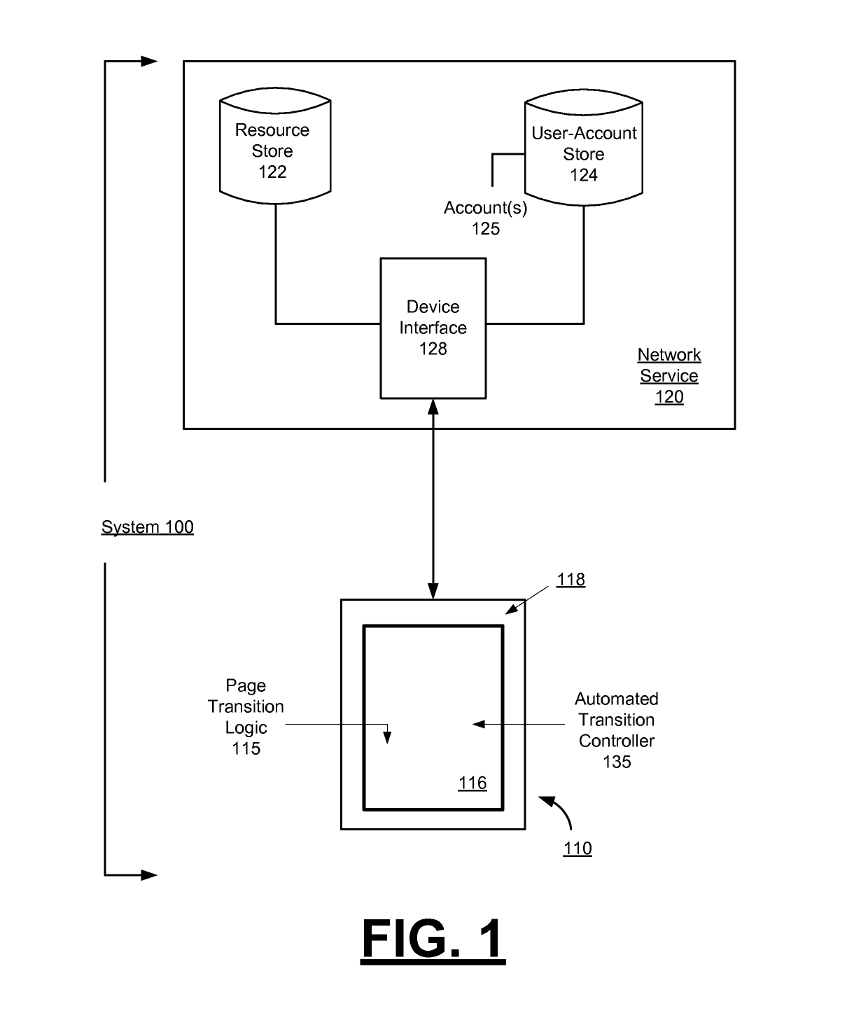

FIG. 1 illustrates a system 100 for utilizing applications and providing e-book services on a computing device, according to an embodiment. In an example of FIG. 1, system 100 includes an electronic display device, shown by way of example as an e-reading device 110, and a network service 120. The network service 120 can include multiple servers and other computing resources that provide various services in connection with one or more applications that are installed on the e-reading device 110. By way of example, in one implementation, the network service 120 can provide e-book services which communicate with the e-reading device 110. The e-book services provided through network service 120 can, for example, include services in which e-books are sold, shared, downloaded and/or stored. More generally, the network service 120 can provide various other content services, including content rendering services (e.g., streaming media) or other network-application environments or services.

The e-reading device 110 can correspond to any electronic personal display device on which applications and application resources (e.g., e-books, media files, documents) can be rendered and consumed. For example, the e-reading device 110 can correspond to a tablet or a telephony/messaging device (e.g., smart phone). In one implementation, for example, e-reading device 110 can run an e-reading application that links the device to the network service 120 and enables e-books provided through the service to be viewed and consumed. In another implementation, the e-reading device 110 can run a media playback or streaming application that receives files or streaming data from the network service 120. By way of example, the e-reading device 110 can be equipped with hardware and software to optimize certain application activities, such as reading electronic content (e.g., e-books). For example, the e-reading device 110 can have a tablet-like form factor, although variations are possible. In some cases, the e-reading device 110 can also have an E-ink display.

In additional detail, the network service 120 can include a device interface 128, a resource store 122 and a user account store 124. The user account store 124 can associate the e-reading device 110 with a user and with an account 125. The account 125 can also be associated with one or more application resources (e.g., e-books), which can be stored in the resource store 122. As described further, the user account store 124 can retain metadata for individual accounts 125 to identify resources that have been purchased or made available for consumption for a given account. The e-reading device 110 may be associated with the user account 125, and multiple devices may be associated with the same account. As described in greater detail below, the e-reading device 110 can store resources (e.g., e-books) that are purchased or otherwise made available to the user of the e-reading device 110, as well as to archive e-books and other digital content items that have been purchased for the user account 125, but are not stored on the particular computing device.

With reference to an example of FIG. 1, e-reading device 110 can include a display screen 116 and a housing 118. In an embodiment, the display screen 116 is touch-sensitive, to process touch inputs including gestures (e.g., swipes). For example, the display screen 116 may be integrated with one or more touch sensors to provide a touch sensing region on a surface of the display screen 116. Additionally, the housing 118 can be integrated with touch sensors to provide one or more touch sensing regions, for example, on the bezel and/or back surface of the housing 118.

In some embodiments, the e-reading device 110 includes features for providing functionality related to displaying paginated content. The e-reading device can include page transitioning logic 115, which enables the user to transition through paginated content. The e-reading device can display pages from e-books, and enable the user to transition from one page state to another. In particular, an e-book can provide content that is rendered sequentially in pages, and the e-book can display page states in the form of single pages, multiple pages or portions thereof. Accordingly, a given page state can coincide with, for example, a single page, or two or more pages displayed at once. The page transitioning logic 115 enables single page transitions, chapter transitions, and/or cluster transitions (e.g., multiple pages at one time).

The page transitioning logic 115 can be responsive to various kinds of interfaces and actions in order to enable page transitioning. In one implementation, the user can signal a page transition even to transition page states by, for example, interacting with the touch sensing region of the display 116. For example, the user can trigger a page turn (e.g., a forward or backward page transition) input by tapping the surface of the display 116. Alternatively, and/or additionally, the user may trigger a page turn input by swiping the surface of the display 116 (e.g., in the direction of the desired page transition).

Additionally, for some embodiments, the page transitioning logic 115 may be responsive to an automated transition controller 135. Specifically, the automated transition controller 135 may “automatically” (e.g., without user input) trigger the page transitioning logic 115 to transition page states after a given duration of time. For example, the automated transition controller 135 may initiate a countdown timer when an initial (and/or new) page state is presented on the display 116. Once initiated, the countdown timer may begin counting down from a predetermined starting value (e.g., 30 seconds). When the countdown timer expires (e.g., reaches zero), the automated transition controller 135 may signal a page turn input to the page transition logic 115. In alternative embodiment, the automated transition controller 135 may trigger a page transition on its own (e.g., without signaling to the page transition logic 115).

For some embodiments, the duration of the countdown timer may substantially correspond with and/or track a reading speed of the user. For example, the duration of the countdown timer may be user-programmable, thus allowing the user to set the “pace” (e.g., frequency) of page transitions based on a desired reading speed. Alternatively, and/or in addition, the duration of the countdown timer may be dynamically adjusted based on user input (e.g., user-initiated page transitions and/or transition delays) to track and/or adapt to the user's actual reading speed.

Hardware Description

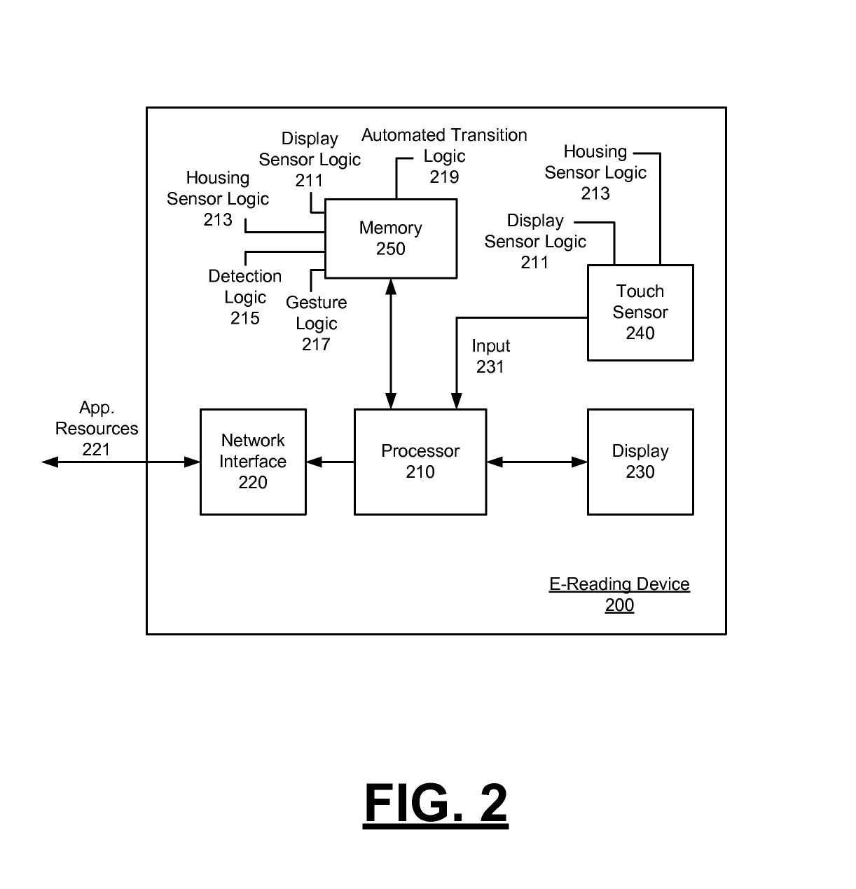

FIG. 2 illustrates an example of an e-reading device 200 or other electronic personal display device, for use with one or more embodiments described herein. In an example of FIG. 2, an e-reading device 200 can correspond to, for example, the device 110 as described above with respect to FIG. 1. With reference to FIG. 2, e-reading device 200 includes a processor 210, a network interface 220, a display 230, one or more touch sensor components 240, and a memory 250.

The processor 210 can implement functionality using instructions stored in the memory 250. Additionally, in some implementations, the processor 210 utilizes the network interface 220 to communicate with the network service 120 (see FIG. 1). More specifically, the e-reading device 200 can access the network service 120 to receive various kinds of resources (e.g., digital content items such as e-books, configuration files, account information), as well as to provide information (e.g., user account information, service requests etc.). For example, e-reading device 200 can receive application resources 221, such as e-books or media files, that the user elects to purchase or otherwise download from the network service 120. The application resources 221 that are downloaded onto the e-reading device 200 can be stored in the memory 250.

In some implementations, the display 230 can correspond to, for example, a liquid crystal display (LCD) or a light emitting diode (LED) display that illuminates in order to provide content generated from processor 210. In some implementations, the display 230 can be touch-sensitive. For example, in some embodiments, one or more of the touch sensor components 240 may be integrated with the display 230. In other embodiments, the touch sensor components 240 may be provided (e.g., as a layer) above or below the display 230 such that individual touch sensor components 240 track different regions of the display 230. Further, in some variations, the display 230 can correspond to an electronic paper type display, which mimics conventional paper in the manner in which content is displayed. Examples of such display technologies include electrophoretic displays, electrowetting displays, and electrofluidic displays.

The processor 210 can receive input from various sources, including the touch sensor components 240, the display 230, and/or other input mechanisms (e.g., buttons, keyboard, mouse, microphone, etc.). With reference to examples described herein, the processor 210 can respond to input 231 from the touch sensor components 240. In some embodiments, the processor 210 responds to inputs 231 from the touch sensor components 240 in order to facilitate or enhance e-book activities such as powering off the device 200 and/or display 230, activating a screen saver, launching an application, and/or otherwise altering a state of the display 230.

In some embodiments, the memory 250 may store display sensor logic 211 that monitors for user interactions detected through the touch sensor components 240 provided with the display 230, and further processes the user interactions as a particular input or type of input. The memory 250 may further store housing sensor logic 213 that monitors for user interactions detected through the touch sensing components 240 provided with portions of the housing of the e-reading device 200. In an alternative embodiment, the display sensor logic 211 and/or the housing sensor logic 213 may be integrated with the touch sensor components 240. For example, one or more of the touch sensor components 240 can be provided as modular components that include integrated circuits or other hardware logic, and such resources can provide some or all of the display sensor logic 211 and/or housing sensor logic 213. In variations, some or all of the display sensor logic 211 and/or housing sensor logic 213 may be implemented with the processor 210 (which utilizes instructions stored in the memory 250), or with an alternative processing resource.

In one implementation, the display sensor logic 211 and/or housing sensor logic 213 may further include detection logic 215 and gesture logic 217. The detection logic 215 implements operations to monitor for the user contacting a surface of the housing and/or display coinciding with the placement of one or more sensor components 240. The gesture logic 217 detects and correlates a particular gesture (e.g., swiping, tapping, punching, etc.) as a particular type of input or user action. The gesture logic 217 can also detect directionality so as to distinguish between, for example, leftward or rightward swipes.

The memory 250 further stores automated transition logic 219 to automatically transition through paginated content based on a passage of time. For example, the automated transition logic 219 may transition the contents of the display 230 from a current page state to a new page state after the current page state has remained on the display 230 for a given duration (e.g., based on a countdown timer). Specifically, the new page state may be subsequent to the current page state in a paginated sequence (e.g., corresponding to successive pages of an e-book). For some embodiments, the automated transition logic 219 may initiate and/or reset the countdown timer each time the display 230 is refreshed or otherwise updated with content pertaining to a new page state. This reduces the amount of user-interaction needed to advance and/or read through a set of paginated content.

For some embodiments, the automated transition logic 219 may also be responsive to user inputs. For example, a user may require more time to read and/or re-read the content pertaining to the current page state. Accordingly, the user may signal a transition delay input by interacting with one or more of the touch sensor components 240 (e.g., by tapping a particular region of the display 230). The automated transition logic 219 may respond to the transition delay input by adjusting the countdown timer to postpone or otherwise delay the transitioning of the content of the display 230. The automated transition logic 219 may adjust the countdown timer, for example, by: adding additional time (e.g., a predetermined time increment) to the current state of the countdown timer; slowing down the rate at which the countdown timer counts down (e.g., from 1-second intervals to 10-second intervals); and/or resetting the countdown timer (e.g., starting the countdown over again).

In another example, a user may finish reading the content pertaining to the current page state before the countdown timer expires. Accordingly, the user may signal a page turn input (e.g., by tapping a different region of the display 230 or swiping the display 230 from left to right) to manually trigger a page transition. The automated transition logic 219 may respond to the page turn input by immediately transitioning the content of the display 230 from the current page state to a new page state (e.g., prior to expiration of the countdown timer). The automated transition logic 219 may then reset the countdown timer upon transitioning to the new page state.

Automated Page Transitions

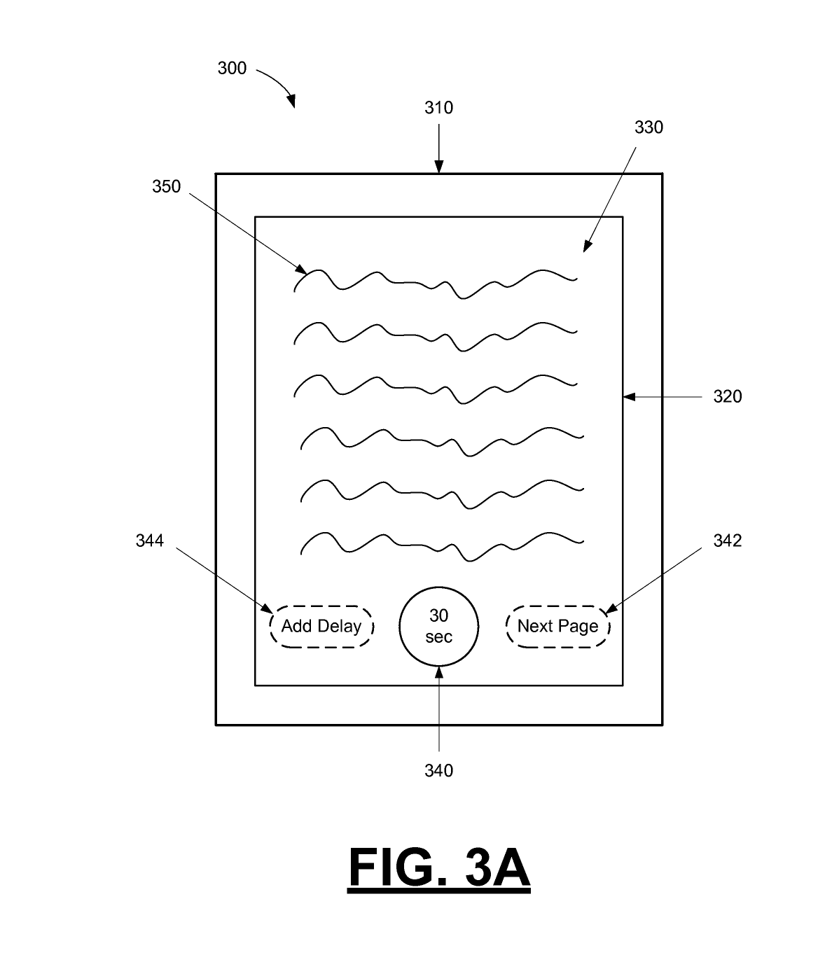

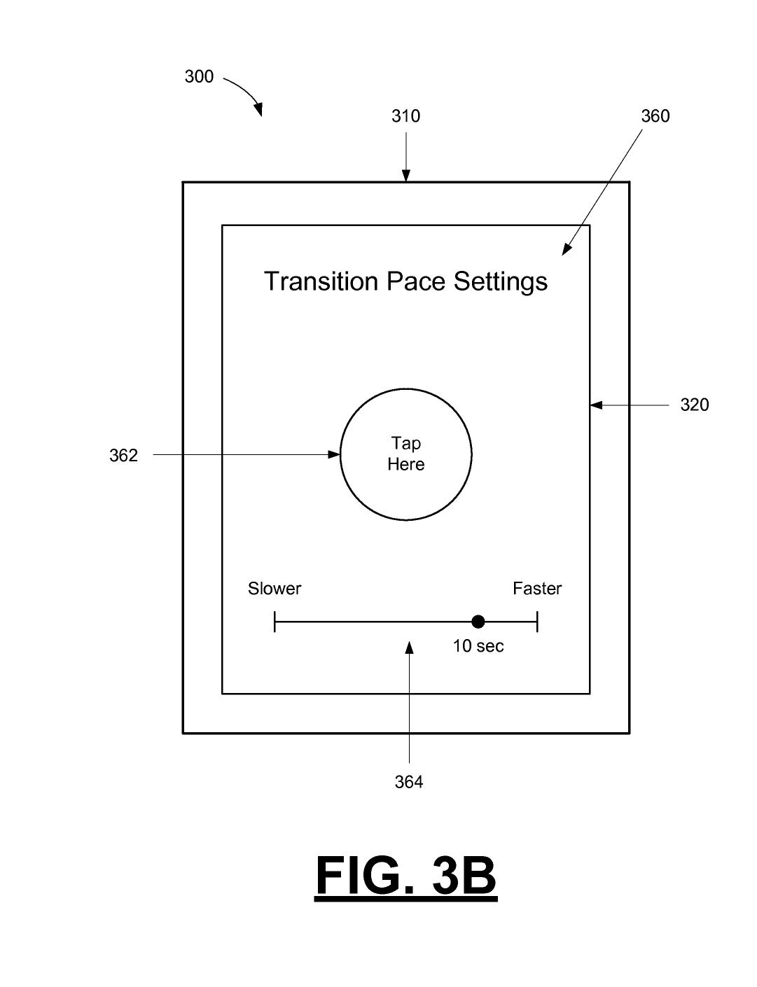

FIGS. 3A-3B illustrate embodiments of an e-reading device that automatically transitions a display state based on a countdown timer. The e-reading device 300 includes a housing 310 and a display screen 320. The e-reading device 300 can be substantially tabular or rectangular, so as to have a front surface that is substantially occupied by the display screen 320 so as to enhance content viewing. More specifically, the front surface of the housing 310 may be in the shape of a bezel surrounding the display screen 320. The display screen 320 can be part of a display assembly, and can be touch sensitive. For example, the display screen 320 can be provided as a component of a modular display assembly that is touch-sensitive and integrated with housing 310 during a manufacturing and assembly process.

A touch sensing region 330 is provided with at least a portion of the display screen 320. Specifically, the touch sensing region 330 may coincide with the integration of touch sensors with the display screen 320. For some embodiments, the touch sensing region 330 may substantially encompass a surface of the display screen 320. Further, the e-reading device 300 can integrate one or more types of touch-sensitive technologies in order to provide touch sensitivity on the touch sensing region 330 of the display screen 320. It should be appreciated that a variety of well-known touch sensing technologies may be utilized to provide touch-sensitivity, including, for example, resistive touch sensors, capacitive touch sensors (using self and/or mutual capacitance), inductive touch sensors, and/or infrared touch sensors.

For example, the touch-sensing feature of the display screen 320 can be employed using resistive sensors, which can respond to pressure applied to the surface of the display screen 320. In a variation, the touch-sensing feature can be implemented using a grid pattern of electrical elements which can detect capacitance inherent in human skin. Alternatively, the touch-sensing feature can be implemented using a grid pattern of electrical elements which are placed over or just beneath the surface of the display screen 320, and which deform sufficiently on contact to detect touch from an object such as a finger.

The e-reading device 300 may further include a backlight 330 to provide illumination for the display 320. The backlight 330 may be comprised of one or more light-emitting diodes (LEDs), an electroluminescent panel (ELP), one or more fluorescent lamps, and/or one or more incandescent light bulbs. For example, one or more components of the backlight 330 may be provided under the display 320, to illuminate the display 320 from behind. Alternatively, and/or in addition, one or more components of the backlight 330 may be provided within the bezel of the housing 310, to provide side illumination to the display 320 (e.g., from one or more edges of the display). Still further, in some implementations, the e-reading device 300 may be illuminated from the front.

With reference to FIG. 3A, the e-reading device 300 may display content 350 pertaining to a particular page state of an e-book or other form of paginated content. As used herein, a “display state” may refer to the content 350 presented on the display 320 at any given time. For some embodiments, the display 320 may also include a graphical representation of a countdown timer 340. In the example shown, the graphical representation of the countdown timer 340 indicates a state of the countdown timer (e.g., the amount of time remaining on the countdown timer). In other embodiments, the graphical representation of the countdown timer 340 may be in the form of a symbol (such as an ellipsis) that appears only when the countdown timer is about to expire (e.g., when there are 3 seconds remaining on the countdown timer). Still further, for some embodiments, the graphical representation of the countdown timer 340 may be removed by a user (e.g., if the user finds it distracting).

For some embodiments, the display 320 may also include a “next page” icon 342 and an “add delay” icon 344. A user may provide a page turn input, for example, by tapping a region of the display 320 that coincides with the next page icon 342. Upon receiving a page turn input, the e-reading device 300 may transition the display state to reflect a page transition. More specifically, the e-reading device 300 may transition the content 350 of the display 320 to correspond with a new (e.g., successive) page state. After transitioning to the new page state, the e-reading device 300 may subsequently reset (and re-initiate) the countdown timer 340.

A user may provide a transition delay input, for example, by tapping a region of the display 320 that coincides with the add delay icon 344. Upon receiving a transition delay input, the e-reading device 300 may adjust the countdown timer to postpone or otherwise delay the transitioning of the display state. As described above, the countdown timer may be adjusted by adding additional time to the current state of the timer, slowing the rate which the timer counts down, and/or resetting the countdown timer.

For some embodiments, the duration of the countdown timer may be based on a pre-determined timer value. For other embodiments, the timer value may be user-programmable. For example, FIG. 3B shows a “transition pace settings” menu 360 wherein a user may adjust the duration and/or rate of the countdown timer 340. Specifically, the transition pace settings menu 360 may include one or more input mechanisms for configuring a rate and/or interval of automatic page transitions for an e-book. Further, in some embodiments, the transition pace settings menu 360 may display the current page transition rate to the user (e.g., “10 sec”).

In a particular example, the transition pace settings menu 360 includes a tapping input feature 362 and a scrolling input feature 364. A user may interact with the tapping input feature 362 by tapping a region of the display 320 that coincides with the “tap here” icon. The e-reading device 300 may associate the frequency of the user's taps with a pace or rate at which page transitions are to occur (e.g., time interval between successive page transitions). For example, the e-reading device 300 may determine an average duration between successive user taps, and associate the average duration with a timer value. The timer value may represent the duration (e.g., initial state) of the countdown timer 340.

A user may interact with the scrolling input feature 364 by tapping and/or dragging a region of the display 320 that coincides with the scroll bar. For example, the user may select a slower frequency for the page transitions by tapping a left-hand portion of the scroll bar (e.g., in the region marked “slower”). The user may also select a higher frequency for the page transitions by tapping a right-hand portion of the scroll bar (e.g., in the region marked “faster”). Alternatively, and/or in addition, the user may increase and/or decrease the frequency of page transitions by tapping and dragging the slider (e.g., represented in FIG. 3B as a dot or circular object) in the desired direction. The e-reading device 300 may associate the frequency indicated by the relative placement or position of the slider with the timer value used by the countdown timer.

Page Transition Functionality

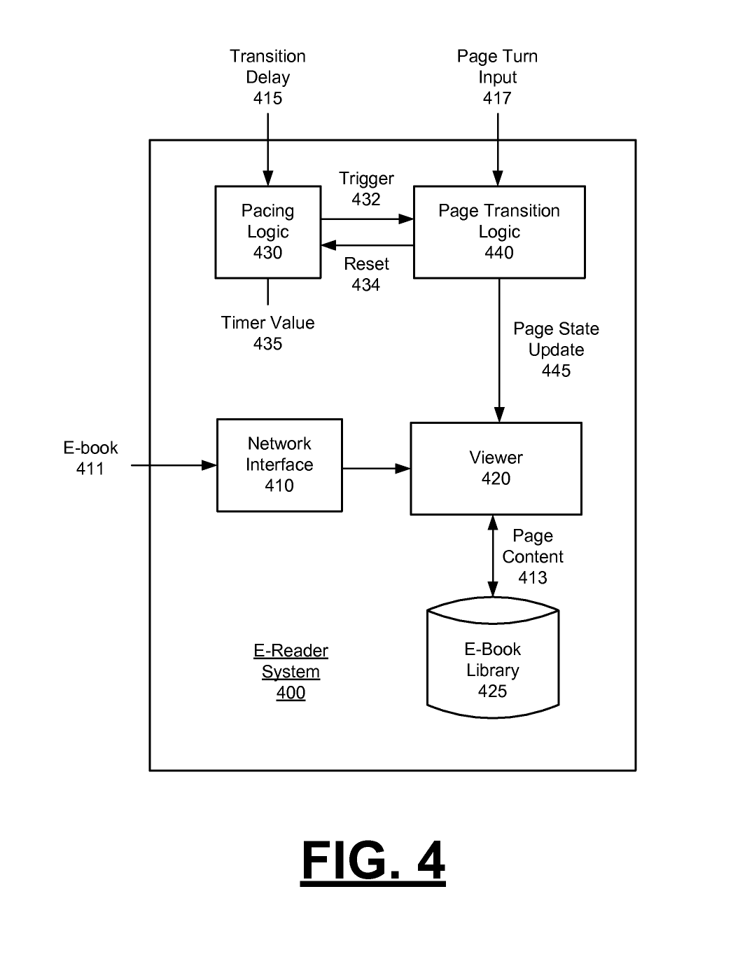

FIG. 4 illustrates an e-reading system 400 for displaying e-book content, according to one or more embodiments. An e-reading system 400 can be implemented as, for example, an application or device, using components that execute on, for example, an e-reading device such as shown with examples of FIGS. 1, 2 and 3A-3B. Furthermore, an e-reading system 400 such as described can be implemented in a context such as shown by FIG. 1, and configured as described by an example of FIG. 2 and FIGS. 3A-3B.

In an example of FIG. 4, a system 400 includes a network interface 410, a viewer 420, pacing logic 430, and page transition logic 440. As described with an example of FIG. 1, the network interface 410 can correspond to a programmatic component that communicates with a network service in order to receive data and programmatic resources. For example, the network interface 410 can receive an e-book 411 from the network service that the user purchases and/or downloads. E-books 411 can be stored as part of an e-book library 425 with memory resources of an e-reading device (e.g., see memory 250 of e-reading device 200).

The viewer 420 can access e-book content 413 from a selected e-book, provided with the e-book library 425. The e-book content 413 can correspond to one or more pages that comprise the selected e-book. Additionally, the e-book content 413 may correspond to portions of one or more pages of the selected e-book. The viewer 420 renders the one or more pages on a display screen at a given instance, corresponding to the retrieved e-book content 413. The display state rendered by the viewer 420 can correspond to a particular page, set of pages, or portions of one or more pages of the selected e-book that are displayed at a given moment.

The page transition logic 440 can be provided as a feature or functionality of the viewer 420. Alternatively, the page transition logic 440 can be provided as a plug-in or as independent functionality form the viewer 420. The page transition logic 440 can signal page state updates 445 to the viewer 420. The page state updates 445 can specify a page transition, causing the viewer 420 to render a new page. In specifying the page state update 445, the page transition logic 440 can provide for single page turns, multiple page turns, or chapter turns. The page state update 445 for a single page turn causes the viewer 420 to transition a page state by presenting page content 413 that is next in sequence (e.g., forward or backward) to the page content that is being displayed. The page state update 445 for a multi-page turn causes the viewer 420 to transition a page state by presenting page content 413 that is a jump forward or backward in sequence from the page state under display. Likewise, the page state update 445 for a chapter turn causes the viewer 420 to transition a page state by presenting page content 413 that is a subsequent or previous chapter in sequence to a chapter of the current page state. Accordingly, the page state update 445 can signify a transition value representing the page state that is to be displayed next (e.g., single-page transition or ten-page transition) and/or a transition type (e.g., page or chapter transition).

According to some embodiments, the page transition logic 440 can be responsive to different kinds of input, including an input action which signifies page turns (or page transitions) 417. The page turn input 417 can include, for example, single page turns, multi-page turns and/or chapter turns. The type of page turn input 417 can be determined from the type of input provided. For example, the page turn input 417 can be provided by the user interacting with the one or more touch sensors provided on a surface of a housing and/or display of the e-reading system 400. Specifically, single taps on the touch sensors may be interpreted as single page turns, whereas a touch-and-hold can be interpreted as a multi-page turn or chapter input. Still further, actions such as tap and swipe can be interpreted as chapter transitions. In response to receiving a page turn input 417, the page transition logic 440 signals the page state update 445 to the viewer 420. The viewer updates the page content 413 to reflect the change represented by the page state update 445 (e.g., single page transition, multi-page transition, or chapter transition).

For some embodiments, the page transition logic 440 may also be response to triggers 432 from the pacing logic 430. For example, the pacing logic 430 may initiate a countdown timer each time the viewer 420 receives a page state update 445. More specifically, the page transition logic 440 may send a reset signal 434 to the pacing logic 430 when it outputs the page state update 445 to the viewer 420. The pacing logic 430 responds to the reset signal 434 by starting (and/or resetting) the countdown timer. The initial duration of the countdown timer may be based on a timer value 435 stored by the pacing logic 430. However, the pacing logic 430 may dynamically adjust (e.g., increase or delay) the duration of the countdown timer in response to transition delay inputs 415. For example, the pacing logic 430 may add additional time (e.g., in 5- or 10-second increments) to the current state of the countdown timer with each transition delay input 415 received from a user.

When the countdown timer expires (e.g., reaches zero), the pacing logic 430 sends the trigger 432 to the page transition logic 440. The page transition logic 440 responds to the trigger 432 by outputting a page state update 445 (e.g., for a single page turn) to the viewer 420. It should be noted that, in some instances, the page transition logic 440 may receive a page turn input 417 before the countdown timer expires. The page transition logic 440 may respond to page turn inputs 417 by immediately outputting a corresponding page state update 445 to the viewer (e.g., without waiting for the trigger 432 from the pacing logic 430) and sending the reset signal 434 to the pacing logic 430.

For some embodiments, the timer value 435 may be user-programmable. For example, a user may manually configure the timer value 435 to correspond with a desired reading speed (e.g., as described above with respect to FIG. 3B). For other embodiments, the pacing logic 430 may dynamically adjust the timer value 435 to track and/or adapt to the user's actual reading speed. Specifically, the pacing logic 430 may periodically adjust the timer value 435 based on an average duration between successive page state transitions. For example, the timer value 435 may be increased each time the pacing logic 430 receives a transition delay 415 (e.g., indicating that the duration of the countdown timer is faster than desired). On the other hand, the timer value 435 may be decreased each time the pacing logic 430 receives a reset signal 434 prior to expiration of the countdown timer (e.g., indicating that the duration of the countdown timer is slower than desired).

Methodology

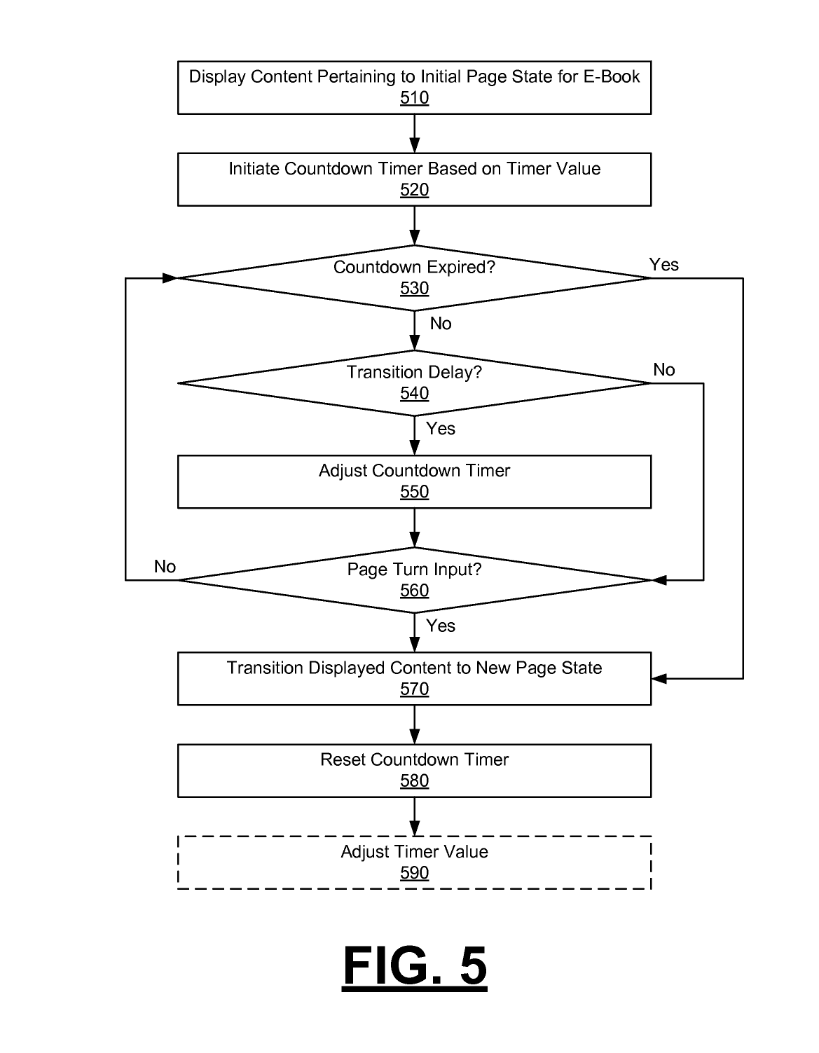

FIG. 5 illustrates a method of continuously scrolling e-book content, according to one or more embodiments. In describing an example of FIG. 5, reference may be made to components such as described with FIGS. 2 and 3A-3B for purposes of illustrating suitable components for performing a step or sub-step being described.

With reference to an example of FIG. 2, the e-reading device 200 may first display content pertaining to an initial page state for an e-book (510). For example, the device 200 may display a single page of an e-book corresponding to the content being read by the user. Alternatively, the device 200 may display multiple pages side-by-side to reflect a display mode preference of the user.

The e-reading device 200 then initiates a countdown timer based on a corresponding timer value (520). For example, the processor 210, in executing the automated transition logic 219, may initiate the countdown timer when new content is presented on the display 230. As described above, the timer value may be manually configured (e.g., by a user of the e-reading device 200) to correspond with a desired reading speed. Alternatively, and/or in addition, the timer value may adaptively track the user's actual reading speed. For example, the timer value may correspond with an average duration between successive page transitions.

While the countdown timer is counting down, and before the countdown timer has expired (530), the e-reading device 200 may continuously monitor for user inputs (540-560). For example, the processor 210 can receive inputs 231 from the touch sensor components 240. More specifically, the processor 210, in executing the display sensor logic 211 and/or housing sensor logic 213, may monitor for touch-based inputs (and/or gesture-based inputs) corresponding with a transition delay (540) and/or a page turn (560).

Upon detecting a transition delay input (540), the e-reading device 200 may adjust the countdown timer accordingly (550). Specifically, the processor 210 may increase or otherwise delay the duration of the countdown timer in response to transition delay inputs from a user. For example, the processor 210 may delay the countdown timer by adding additional time (e.g., in 5- or 10-second increments) to the current state of the countdown timer.

Upon detecting a page turn input (560), and/or expiration of the countdown timer (530), the e-reading device 200 may transition the displayed content to reflect a new page state (570). For example, the new page state may succeed the initial (or current) page state in a sequence of pages (or content) pertaining to the e-book. For some embodiments, the new page state may correspond with a multi-page or chapter transition (e.g., based on a particular type of user input).

The e-reading device 200 may subsequently reset the countdown timer (580). For example, the processor 210 may re-initialize the countdown timer to the timer value in preparation for the next automated page-state transition. For some embodiments, the e-reading device 200 may further adjust the timer value (590) after transitioning the displayed content to the new page state. For example, the processor 210 may increase or decrease the timer value based on an average duration between successive page state transitions. Accordingly, the timer value may adaptively track the user's actual reading speed.

It should be noted that the method 500 may be automatically repeated each time the content of the display 230 is refreshed (e.g., in a cyclical manner). For example, the “new” page state of a previous page transition cycle may correspond to the “initial” or current page state of a subsequent page transition cycle. In this manner, the e-reading device 200 may automatically transition through the pages of an e-book with little or no user interaction involved.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A computing device comprising:
a display assembly including a screen;
a housing that at least partially circumvents the screen so that the screen is viewable;
a processor provided within the housing, the processor operating to:
display content pertaining to a first page state for an e-book;
initiate a countdown timer based on a first timer value; and
upon expiration of the countdown timer, automatically transition the displayed content to correspond with a second page state of the e-book.

2. The computing device of claim 1, wherein the processor is to further:
display a representation of the countdown timer on the screen of the display assembly.

3. The computing device of claim 2, wherein the representation indicates a state of the countdown timer.

4. The computing device of claim 1, wherein the processor is to further:
receive a first user input corresponding to a transition delay; and
in response to the first user input, adjust the countdown timer to delay the transitioning of the displayed content.

5. The computing device of claim 4, wherein the processor is to further:
increase the first timer value in response to the first user input.

6. The computing device of claim 1, wherein the processor is to further:
receive a second user input corresponding to a page turn; and
in response to the second user input, and prior to expiration of the countdown timer, transition the displayed content to correspond with the second page state.

7. The computing device of claim 6, wherein the processor is to further:
decrease the first timer value in response to the second user input.

8. The computing device of claim 1, wherein the processor is to further:
determine the first timer value based, at least in part, on an average duration between successive page transitions of the e-book.

9. The computing device of claim 1, wherein the first timer value is a user-programmable value.

10. The computing device of claim 1, wherein the processor is to further:
reset the countdown timer after transitioning the displayed content from the first page state to the second page state.

11. A method for operating a computing device, the method being implemented by one or more processors and comprising:
displaying content pertaining to a first page state for an e-book;
initiating a countdown timer based on a first timer value; and
upon expiration of the countdown timer, automatically transitioning the displayed content to correspond with a second page state of the e-book.

12. The method of claim 11, further comprising:
displaying a representation of the countdown timer with the displayed content.

13. The method of claim 12, wherein the representation indicates a state of the countdown timer.

14. The method of claim 11, further comprising:
receiving a first user input corresponding to a transition delay; and
in response to the first user input, adjusting the countdown timer to delay the transitioning of the displayed content.

15. The method of claim 14, further comprising:
increasing the first timer value in response to the first user input.

16. The method of claim 11, further comprising:
receiving a second user input corresponding to a page turn; and
in response to the second user input, and prior to expiration of the countdown timer, transitioning the displayed content to correspond with the second page state.

17. The method of claim 16, further comprising:
decreasing the first timer value in response to the second user input.

18. The method of claim 11, further comprising:
determining the first timer value based, at least in part, on an average duration between successive page transitions of the e-book.

19. The method of claim 11, further comprising:
resetting the countdown timer after transitioning the displayed content from the first page state to the second page state.

20. A non-transitory computer-readable medium that stores instructions, that when executed by one or more processors, cause the one or more processors to perform operations that include:
displaying content pertaining to a first page state for an e-book;
initiating a countdown timer based on a first timer value; and
upon expiration of the countdown timer, automatically transitioning the displayed content to correspond with a second page state of the e-book.
